(19) United States
(12) Patent Application Publication
(10) Pub. No.: US 2025/0245135 A1
(43) Pub. Date: Jul. 31, 2025

(54) DYNAMIC CIRCUIT BRANCH PREDICTION

(71) Applicant: International Business Machines Corporation, Armonk, NY (US)

(72) Inventors: Ryan Woo, Tenafly, NJ (US); Diego Moreda Rodriguez, Ribadeo (ES); Jessie Yu, Pleasant Valley, NY (US); Atsuko Shimizu, Mount Kisco, NY (US)

(21) Appl. No.: 18/792,088

(22) Filed: Aug. 1, 2024

(30) Foreign Application Priority Data
Jan. 31, 2024 (EP) 24382094.1

(51) Int. Cl. G06F 11/36; G06N 5/022

(52) U.S. Cl. CPC G06F 11/3688; G06N 5/022

(57) ABSTRACT

Various systems and methods are presented herein regarding automatically predicting an outcome of a conditional operation, and in the event of the prediction being incorrect, implementing a rewind operation to undo any changes in state, etc., resulting from implementing the incorrectly predicted program code. The program code can be computer instructions to control operation of a quantum computing system, a quantum circuit, and suchlike. The rewind operation can comprise of application of a conjugate transpose or a state compliment. The predicted outcome can be based on an outcome of a previously executed conditional operation that is the same or similar to the conditional operation of interest. A characteristic of the quantum circuit can be determined and a weighting generated therefrom, wherein the weighting can be applied to the prediction to render the prediction in accordance with a condition of operation of the quantum circuit.

### BACKGROUND

The subject disclosure relates to automatically determining progress and outcome of quantum programs for application in a quantum computing environment.

### SUMMARY

The following presents a summary to provide a basic understanding of one or more embodiments described herein. This summary is not intended to identify key or critical elements, or delineate any scope of the different embodiments and/or any scope of the claims. The sole purpose of the Summary is to present some concepts in a simplified form as a prelude to the more detailed description presented herein.

In one or more embodiments described herein, systems, devices, computer-implemented methods, methods, apparatus and/or computer program products are presented that facilitate automatically predicting an outcome of a conditional operation, and in the event of the prediction being incorrect, automatically implementing a rewind operation to undo any changes in state, etc., resulting from implementing the incorrectly predicted program code.

According to one or more embodiments, a system is provided to predict an outcome of a conditional operation, and in the event of the prediction is incorrect, to implement a rewind operation. The system can comprise a memory operatively coupled to the system, wherein the memory stores computer executable components and a processor that executes the computer executable components stored in the memory. The computer executable components can comprise a prediction component configured to parse program code to identify a conditional operation in the program code, further generate a prediction of an outcome of the conditional operation, and in a further embodiment, speculatively execute an operation in the program code in accordance with the prediction. The computer executable components can further comprise a rewind component configured to, in response to a determination that the prediction was incorrect, rewind the speculatively executed operation. In an embodiment, the program code can be configured to control operation of a quantum computer system.

In another embodiment, the conditional operation can comprise executing a first operation or executing a second operation, wherein the first operation is speculatively executed by the prediction component.

In another embodiment, the rewind component can be further configured to monitor execution of the first operation to determine a first state resulting from the speculative execution of the first operation. In an embodiment, the rewind component can be further configured to generate a rewind operation configured to enact a second state, wherein the second state is a conditional state prior to speculative execution of the first operation, and further apply the rewind operation to the speculatively executed operation. In an embodiment, the rewind operation can comprise one of a conjugate transpose of the first state, a compliment of the first state, utilizing a sequence of gates having an operation that is the compliment to the first state; utilizing a sequence of operations having a combined operation that is the compliment of the first state, or a sequence of gates and operations that combine to be the compliment of the first state.

In a further embodiment, the conditional operation in the program code is a first conditional operation and the program code is a first program code, wherein the prediction component can be further configured to identify second program code having a second conditional operation similar to the first conditional operation in the first program code. The second program code is executed prior to the first program code. The prediction component can be further configured to identify a second prior outcome of the second conditional operation, and further generate the predicted outcome of the first conditional operation based on the second prior outcome of the second conditional operation. In an embodiment, the conditional operation can apply to a conditional operation of one of a logic gate or a quantum bit (qubit) in a quantum circuit.

In another embodiment, the computer executable components can further comprise a weighting component configured to receive a characteristic regarding the logic gate or the qubit, further generate a weighting based on the characteristic and further apply the weighting to the prediction to adjust the prediction in accordance with the characteristic. In an embodiment, the characteristic is at least one of a high readout error, crosstalk, or entanglement.

In other embodiments, elements described in connection with the disclosed systems can be embodied in different forms such as computer-implemented methods, computer program products, or other forms. In an embodiment, a computer-implemented method can comprise automatically (a) predicting an outcome of a conditional operation in a program code, wherein the program code can be configured to control operation of a quantum computer system, (b) speculatively executing an operation in the program code in accordance with the prediction, and (c) rewinding, in response to a determination that the prediction was incorrect, the speculatively executed operation. In an embodiment, the conditional operation can comprise executing a first operation or executing a second operation.

In a further embodiment, the computer-implemented method can further comprise monitoring execution of the first operation and further determining a first state resulting from the speculative execution of the first operation. In another embodiment, the computer-implemented method can further comprise, generating a rewind operation configured to enact a second state, and further applying the rewind operation to the speculatively executed operation, wherein the second state is a conditional state prior to speculative execution of the first operation. In an embodiment, the rewind operation can comprise one of a conjugate transpose of the first state, a compliment of the first state, utilizing a sequence of gates having an operation that is the compliment to the first state; utilizing a sequence of operations having a combined operation that is the compliment of the first state, or a sequence of gates and operations that combine to be the compliment of the first state.

In a further embodiment, the computer-implemented method can further comprise identifying, in a quantum circuit, one of a logic gate or a quantum bit (qubit) to which the conditional operation applies, and further receiving a characteristic regarding the logic gate or the qubit. In another embodiment, the computer-implemented method can further comprise generating a weighting based on the characteristic and further applying the weighting to the prediction to adjust the prediction in accordance with the characteristic.

Another embodiment can further comprise a computer program product stored on a non-transitory computer-readable medium and comprising machine-executable instructions, wherein, in response to being executed, the machine-executable instructions cause a machine to perform operations, wherein the operations can comprise predicting an outcome of a conditional operation in a program code, wherein the program code is configured to control operation of a quantum computer system, and further speculatively executing an operation in the program code in accordance with the prediction. In a further embodiment, the operations can further comprise rewinding, in response to a determination that the prediction was incorrect, the speculatively executed operation.

In an embodiment the conditional operation can comprise executing a first operation or executing a second operation, such that the operations can further comprise monitoring execution of the first operation. In a further embodiment, the operations can further comprise determining a first state resulting from the speculative execution of the first operation, further generating a rewind operation configured to enact a second state, and further applying the rewind operation to the speculatively executed operation, wherein the second state is a conditional state of the quantum computer system prior to speculative execution of the first operation. In an embodiment, the rewind operation can comprise one of a conjugate transpose of the first state, a compliment of the first state, utilizing a sequence of gates having an operation that is the compliment to the first state; utilizing a sequence of operations having a combined operation that is the compliment of the first state, or a sequence of gates and operations that combine to be the compliment of the first state.

In a further embodiment, the operations can further comprise identifying, in a quantum circuit in the quantum computer system, one of a logic gate or a quantum bit (qubit) to which the conditional operation applies, further receiving a characteristic regarding the logic gate or the qubit, further generating a weighting based on the characteristic, and further applying the weighting to the prediction to adjust the prediction in accordance with the characteristic.

### DESCRIPTION OF THE DRAWINGS

One or more embodiments are described below in the Detailed Description section with reference to the following drawings:

FIG. 1 illustrates a system which can be utilized to automatically predict an outcome of a conditional operation and further automatically rewind the conditional operation in the event of a misprediction, in accordance with one or more embodiments.

FIG. 2 presents a system which further expands upon the system presented in FIG. 1. FIG. 2 illustrates various components which can be utilized to predict/rewind a conditional operation, in accordance with one or more embodiments.

FIG. 3, is a schematic presenting vectorization and similarity determination of a base code with a prior code(s), in accordance with an embodiment.

FIG. 4A presents a schematic illustrating a prediction being made and a rewind operation being compiled, in accordance with an embodiment.

FIG. 4B presents a schematic illustrating a prediction being made and a rewind operation being compiled, in accordance with an embodiment.

FIG. 5 illustrates a computer-implemented process for predicting an outcome of a conditional operation performed on a quantum computing system, and functions pertaining thereto, according to one or more embodiments.

FIG. 6 illustrates a computer-implemented process for predicting implementation of a program code based on a pre-existing code, according to one or more embodiments.

FIG. 7 illustrates a computer-implemented process for potentially improving a base code based on a pre-existing code characterized for implementation on a quantum computing system, according to one or more embodiments.

FIG. 8 illustrates a computer-implemented process for adjusting a prediction of a conditional outcome based on one or more characteristics present at a system architecture, according to one or more embodiments.

FIG. 9 depicts an example schematic block diagram of a computing environment with which the disclosed subject matter can interact/be implemented at least in part, in accordance with various aspects and implementations of the subject disclosure.

FIG. 10 presents a quantum computing system one which one or more embodiments presented herein can be implemented, in accordance with various aspects and implementations of the subject disclosure.

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Ranges A-n and 1-i are utilized herein to indicate a respective plurality of devices, components, statements, attributes, etc., where n and i are any positive integer. The terms characterize, categorize, identify, determine, are used interchangeably herein.

A quantum computer program (QP) can comprise source code written in any language, specification, markup language, etc., providing instructions for operation of a quantum computer system and/or a quantum circuit associated therewith. QP's can be written/executed at any language/programming level, from high-level languages that may be completely agnostic to the architecture of the quantum system on which the program is to run, through to low-level assembly languages which may be specific to/near to operation of the quantum computing system. In an aspect, a high-level language can comprise text, commands, parameters, terms, and suchlike, that are readily identifiable to a computer programmer having a degree of familiarity/competency with the high-level language, e.g., a programmer familiar with the PYTHON programming language. Further, a low-level language may be in a format such that a human computer programmer may not be able to readily discern functionality of the code, code structure, etc. In an aspect, the low-level language can be machine-code, a mathematical representation of the high-level language such as vectored statements, and suchlike.

A quantum computer system (also referred to herein as a quantum unit) can comprise, in a non-limiting list, a quantum device, a quantum simulator, a quantum circuit, part of the hardware or software comprising or related to a quantum device, or any other system that computes/generates information using a specific hardware arrangement, and suchlike.

Execution of a QP on a quantum computer system provides insight to the function/intent of the QP with regard to equipment utilized by the QP, arrangement and execution of quantum logic gates, laser/microwave pulsing of qubits, pulse processing, etc., for the quantum circuit of the quantum computing system.

In an aspect, a quantum circuit can be a dynamic circuit, wherein operation of the quantum circuit progresses as a function of conditional statements/instructions, e.g., conditional jumps. A quantum circuit can comprise of an extended network/array of logic gates, quantum bits (qubits), and suchlike, whereby outcomes of conditional statements at a respective gate, etc., creates a branched configuration. An example conditional operation can comprise a first branch of the QP is “taken”, such a next/sequential line/segment of the QP is executed, while if a second branch of the QP is “taken”, a conditional jump occurs in execution of the QP with a fetch-decode-execute operation being performed on a target portion/memory address of code pertaining to the conditional jump. An outcome of a conditional statement determines the next statement in a QP to be executed, and accordingly, which branch of the dynamic circuit is to be navigated/executed next.

In an aspect, to facilitate expedited execution of the QP, rather than executing each statement in the QP in a sequential manner, a number of statement blocks of code across the QP can be identified and processed concurrently. Hence, rather than executing the QP as code block A, await determination of conditional outcome of code block A, then execute the selected branch, e.g., code block C selected based on a conditional jump from code block A, while not executing unselected code block B, etc., code blocks A, B, C, etc., can be executed concurrently, and in the event of the conditional jump from code block A goes to code block C, code block C has already been executed, and code block B may have also been executed even though it was not utilized. Effectively, one or both code blocks B and C can be speculatively executed prior to the outcome of the conditional operation at code block A being known/resolved.

However, it is possible that the prediction may be incorrect/mispredicted and during execution of the quantum circuit, a branch at a first qubit having an assigned prediction of “not taken”, actually was taken). With a conventional, classical-based (non-quantum) computing system, the sequence of incorrect computations can be simply reset and the computation prediction operation restarted from the last conditional operation for which the prediction was correct.

Such a reset/restart approach is not feasible with a quantum computing system. In an embodiment, in the event of an instruction in a QP is speculatively executed in anticipation of a predicted outcome of a conditional operation, and yet, the prediction is incorrect, a rewind process can be performed for any speculatively executed operation(s). During execution of the speculatively executed instruction, the speculatively executed operation (including the respective qubits pertaining to the segment of code to which the rewind process is applied) can be monitored from which a rewind process can be precompiled. Hence, in the event of a misprediction, the precompiled rewind process can be applied to the speculatively executed operation, thus reducing the time cost/latency introduced by a misprediction. In an embodiment, the rewind process can involve any of:
a) parse a conditional operation to identify a speculative operation (e.g., by memory address) associated with the conditional operation, wherein the speculative operation is executed in expectation of a predicted/particular outcome of the conditional operation;
b) execute the speculative instruction pertaining to the conditional operation;
c) generate/precompile a rewind operation configured to undo execution of the speculative operation;
d) in the event of the prediction was mispredicted and execution of the speculative operation is not required, apply the rewind operation to the speculative operation and any gates, qubits, components/circuitry associated therewith; and/or
e) compile historical data from the rewind operation to further train/finetune the prediction process and/or generate a recommendation regarding the misprediction and how it may be avoided in the future (e.g., update a probability of selection, recommend a new segment of code that increases probability of correct prediction, and suchlike).

In an embodiment, the rewind operation can comprise generating a conjugate transpose/compliment of states/conditions implemented on the qubit(s), gate(s), circuitry/components involved with the mispredicted speculative operation. In a further embodiment, the states of the gates, etc., involved with the misprediction can be represented as a first matrix, whereby the rewind operation can entail precompiling a second matrix comprising the conjugate transpose of the first matrix, and in the event of the misprediction, the second matrix is applied to undo/rewind the states/conditions represented in the first matrix.

In an aspect, it would be useful for anyone involved with development/execution of a QP (e.g., programmer, operator of quantum circuit represented by the QP, and suchlike) to know pre-emptively/prior to executing a given task (e.g., a first task), whether a subsequent task (e.g., the second task, the third task) is required/needed or not. Unfortunately, execution of dynamic circuits require computation of each condition in the respective quantum circuit to be computed prior to execution of the dynamic circuit. Such computational delay can be problematic regarding quantum circuit execution owing to the short coherence time of a qubit, wherein coherence generally relates to the ability of a qubit to retain superposition of the qubit as a function of time. Hence, per the one or more embodiments presented herein, it is advantageous to predict conditions present/operating on a quantum circuit represented by a QP, identify the predicted paths, and pre-emptively execute the predicted paths to complete execution of the QP/quantum circuit faster.

Quantum circuits, or portions thereof, may be operationally executed many times. In an embodiment, advantage can be taken of the knowledge acquired from the repeated prior executions, enabling a prediction of the next shot/execution of a QP to be calculated, e.g., heuristically, based on previous measurements conducted with regard to the quantum circuit and/or the QP. Operational information, process data, and suchlike, generated and obtained from previous code executions/measurements can be available and compiled as historical data/metadata/attributes. For example, if a quantum circuit has instructions regarding Qubit 1 is conditional to a measurement on Qubit 0, it is possible to utilize the result of executing the same conditional from a previous execution(s) to determine whether or not to perform the Qubit 1 instructions, whereby the instructions utilized in the previous execution(s) are the same/similar to the conditional instructions currently relating to Qubit 1.

In an embodiment, the prediction can be further enhanced by applying one or more characteristics of the specific qubit/gate of interest (e.g., where the conditional outcome is being implemented/determined). For example, if a qubit has a high readout error, then a predicted outcome can be skewed/weighted towards an erroneous measurement.

In another embodiment, a quantum simulator can be utilized as part of determining the predicted outcome. For example, while it may not be possible to simulate an entire circuit, as part of the prediction process, a simulation may only be required up until a first conditional operation, whereby the determined output of the prediction can be based on simulating the quantum circuit for any processes/configurations in place/encountered prior to the location of the first conditional operation. Hence, the output of the prediction process at the determined first conditional operation can be subsequently utilized as an initial state to simulate the next portion of the circuit up to the next conditional. For example, the next portion of the circuit is between the location of the circuit pertaining to the determination of the first conditional operation and a location of the circuit pertaining to a determination of a second, subsequent conditional operation.

In an embodiment, artificial intelligence (AI) and machine learning (ML) technologies and techniques can be utilized during compilation of information pertaining to the determination of the conditional operation and/or speculative execution of the conditional determination process, e.g., to enhance probability of a prediction being correct. For example, it may be possible to utilize a long short term memory-based network, a transformer neural network, and suchlike, to analyze the circuit to enhance prediction. AI/ML techniques and technologies can also be utilized in the rewind process.

It is to be appreciated that the various embodiments presented herein are applicable to an entire sequence of program code, as well as identifying/segmenting a base code into a series/collection/group of segments/portions/subsets of code, wherein each portion of code can have a defined/discernible conditional operation.

It is also to be appreciated that while the various embodiments presented herein relate to characterizing computer code in a quantum computing environment, the various embodiments are not so limited and can be applied to any operation/process pertaining to predicting an outcome of executing the computer code, compiling and/or applying a rewind for application in the event of a misprediction. The various embodiments herein are applicable to any environment implementing computer code to control operation of one or more devices, generate a value (e.g., determination of a parameter value), utilize in an information technology (IT) environment, and suchlike.

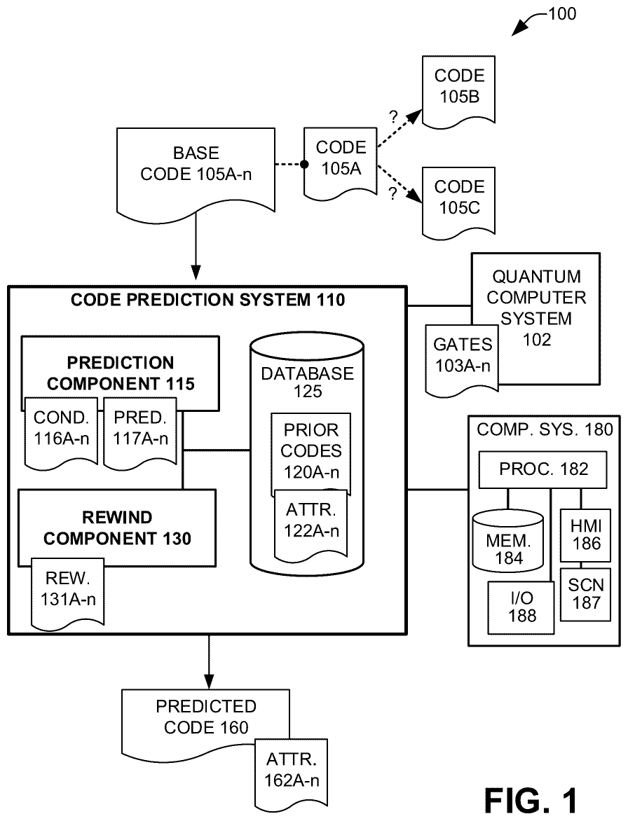

Turning now to the drawings, FIG. 1 illustrates a system 100 which can be utilized to automatically predict an outcome of a conditional operation and further automatically rewind the conditional operation in the event of a misprediction, in accordance with one or more embodiments. System 100 comprises a quantum computer system 102, and further, base code/computer program 105A-n (also known as QP, unpredicted code, original code, segment of QP, and suchlike), that when implemented, is configured/programmed to control operation of the quantum computer system 102. As shown, a first portion of code 105A can include a conditional statement (e.g., conditional statement 116A-n, as further described), execution of the conditional statement can cause implementation of a second portion of code 105B or a third portion of code 105C, however, upon initial analysis, it is unknown which of codes 105B or 105C are to be executed. Implementation of one or more embodiments presented herein reduce the computational cost/latency associated with the uncertainty of code 105B or code 105C being implemented.

Base code 105A-n can be any QP representation/schema, such as a representation of a quantum circuit in a binary serialization format (e.g., QPY), user code in an assembly version such as quantum assembly language (e.g., QASM, QASM3), representation of a sequence of quantum logic gates 103A-n, representation of execution of a pulsing sequence, and suchlike. In an embodiment, quantum computer system 102 can include a quantum circuit comprising qubits/logic gates 103A-n (and any other circuit structure/componentry/architecture to which a conditional operator/operation pertains), a quantum simulator, and suchlike, to which the respective portions of code 105A-n can pertain.

System 100 can further include a code prediction system (CPS) 110 configured to predict a conditional outcome of executing the base code 105A-n, wherein, base code 105A-n can be received at the CPS 110 (e.g., via I/O component 188, as further described). In an example scenario of application of the various embodiments presented herein, base code 105A-n can include/comprise a conditional statement/operation (e.g., a conditional jump) of which the outcome of executing the base code 105 is currently unknown. However, rather than executing base code 105A-n (e.g., on quantum computer system 102, a simulator, and suchlike) and gaining knowledge regarding the content, conditional outcome, etc., of base code 105A-n, per the various embodiments presented herein, execution of base code 105A-n can be predicted as a function of already existing knowledge (e.g., attributes 122A-n) regarding prior codes 120A-n, e.g., the prior codes 120A-n can be implemented on the quantum computer system 102, have already been characterized/predicted, knowledge of their content/structure is available/defined, and suchlike. In an embodiment, an attribute 122A-n of the respective prior codes 120A-n can already be known, wherein the term “attribute” is used herein to indicate knowledge regarding an outcome of a conditional state in a respective prior code 120A-n, application of the prior codes 120A-n, a descriptor/metadata regarding functionality, characterization, categorization, system requirements, code structure, implementation of the code, and suchlike.

In an embodiment, to enable prediction of a conditional outcome, CPS 110 can include a prediction component 115, whereby the prediction component 115 can be configured to identify a conditional statement 116A-n (aka conditional operation, conditional function, conditional jump) in base code 105A-n, and further generate a prediction 117A-n (e.g., a predicted conditional outcome) regarding the outcome of executing the conditional statement 116A-n.

As shown, system 100 can further include a database 125 comprising the collection of prior codes 120A-n and attributes 122A-n, wherein the database 125 can be communicatively coupled to/incorporated within CPS 110.

In an embodiment, attribute 122A-n can indicate a measure as to an outcome of a previously executed code 120A-n, wherein the measure can indicate an outcome probability regarding the prior code 120A executing a first branch 105B of a conditional operation 116A or a second branch 105C of a conditional operation 116A. For example, attribute 122A can indicate that with n-prior executions of prior code 120A, the likelihood that execution propagated along the first branch 105B was any of “strongly not taken”, “weakly not taken”, “weakly taken”, and/or “strongly taken”, whereby the likelihood can be determined based on an average of the executed propagations during which the n-prior executions of prior code 120A was conducted. Attribute 122A can also provide a similar likelihood measure for the second branch 105C. The terms “branch” and respective qubits/logic gates are used interchangeably herein to indicate a first option 105A-n or a second option 105B being available.

In an embodiment, the prior codes 120A-n can include a first subset (e.g., prior codes 120A-H) of prior codes 120A-n which have been previously executed on one or more components included in a quantum computer system (e.g., quantum computer system 102, a simulator of quantum computer system 102, and suchlike). In another embodiment, the prior codes 120A-n can include a second subset (e.g., prior codes 120I-S) of prior codes 120A-n which may not have been previously executed on the quantum computer system, but sufficient knowledge exists regarding the coding/structure of the second subset of prior codes 120A-n such that the second subset of prior codes 120A-n can be utilized to categorize/gain understanding of the base code 105, e.g., regarding an outcome of a conditional statement.

CPS 110 can further include a rewind component 130. Rewind component 130 can be configured to monitor processing of a speculatively executed segment 105A-n of the base code 105, and generate a rewind operation 131A-n therefrom. In an embodiment, the rewind operation 131A-n can be generated by the rewind component 130 concurrent/simultaneously with the generation of prediction 117A-n, such that the rewind operation 131A-n for the speculatively executed segment (e.g., branch code 105A) of base code 105 can be precompiled by the rewind component 130. In the event of the prediction 117A-n to branch code 105A is a misprediction/incorrect, the rewind component 130 can apply (e.g., automatically and immediately) the rewind operation 131A-n to undo/reset the effects of application of the prediction 117A-n on branch 105A. In an example, a conditional operation 116A is predicted by the prediction component 115 with a prediction 117A, however, prediction 117A is determined to be incorrect. Conditional operation 116A may be implemented at a first gate 103A, whereby a number of non-conditional statements/operations either precede, or are subsequent to, the conditional operation 116A. Rewind component 130 can be configured to monitor effect of speculatively executing branch codes 105B and 105C and any associated gates 103A-n and associated non-conditional operations to generate rewind operation 131A. Hence, with prediction 117A along branch 105B being a misprediction, rewind component 130 can apply rewind operation 131A to branch code 105B and/or a quantum computer system/model/circuit/components on which the misprediction 117A was being applied, to unwind the one or more effects of applying the misprediction 117A. As previously mentioned, by precompiling the rewind operation 131A, operational latency of executing misprediction 117A on code 105B can be reduced in contrast with initiating generation of rewind operation 131A at the time prediction 117A was determined to be a misprediction. As also previously mentioned, rewind operation 131A can be a compliment (e.g., a conjugate transpose of the operational condition generated by implementing prediction 117A, e.g., a compliment of a state when code 105B is speculatively, but erroneously, executed.

As further described, in an embodiment, the prediction component 115 can be configured to determine a degree of similarity S between one or more segments of base code 105A-n and the respective codes included in prior codes 120A-n. Based on a determination of S has an acceptable level of similarity (e.g., a similarity threshold value was met or exceeded) between base code 105A and a second code 120A (e.g., in the prior codes 120A-n), known attribute 122A (e.g., in attributes 122A-n) assigned/ascribed/pertaining to the second code 120A can be applied/assigned by the prediction component 115 as a prediction attribute 122A-n of predicting the operational condition 116A-n. Accordingly, per the foregoing, the various embodiments presented herein enable a prediction 117A-n to be determined for a conditional operation 116A-n in base code 105A-n (e.g., code 105A) based on a second code 120A having a known prediction/operational outcome attribute 122A, and further, in response to a determination (e.g., by rewind component 130) of the prediction 117A-n is a misprediction, rewind component 130 can implement a rewind operation 131A-n to reset the quantum computer system/model/simulator to an operational condition prior to execution of prediction 117A-n for conditional operation 116A-n.

As further shown, CPS 110 can be communicatively coupled to/include a computer system 180. Computer system 180 can include a memory 184 that stores the respective computer executable components (e.g., prediction component 115, rewind component 130, misprediction component 205, execution component 217, vector component 220, similarity component 230, weighting component 236, recommendation component 250, archive component 260, and suchlike, as further described herein) and further, a processor 182 configured to execute the computer executable components stored in the memory 184. Memory 184 can further be configured to include database 125, and thus store any of base code 105, predicted code 160A-n, conditional operation 116A-n, prediction 117A-n, attribute 122A-n, rewind operation 131A-n, attribute 162A-n, prior codes 120A-n, thresholds 235A-n, processes 245A-n, notifications 252A-n, similarity indexes S₁₋ₙ, vectors Vx, and suchlike (as further described herein). The computer system 180 can further include a human machine interface (HMI) 186 (e.g., a display, a graphical-user interface (GUI)) which can be configured to present various information including base code 105A-n, conditional operation 116A-n, prediction 117A-n, prior codes 120A-n, attribute 122A-n, predicted code 160A-n, notifications 252A-n, and suchlike, (as further described) per the various embodiments presented herein. HMI 186 can include an interactive display/screen 187 to present the various information. Computer system 180 can further include an I/O component 188 to receive and/or transmit respectively base code 105A-n, predicted code 160A-n, settings for thresholds 235A-n, notifications 252A-n, and suchlike.

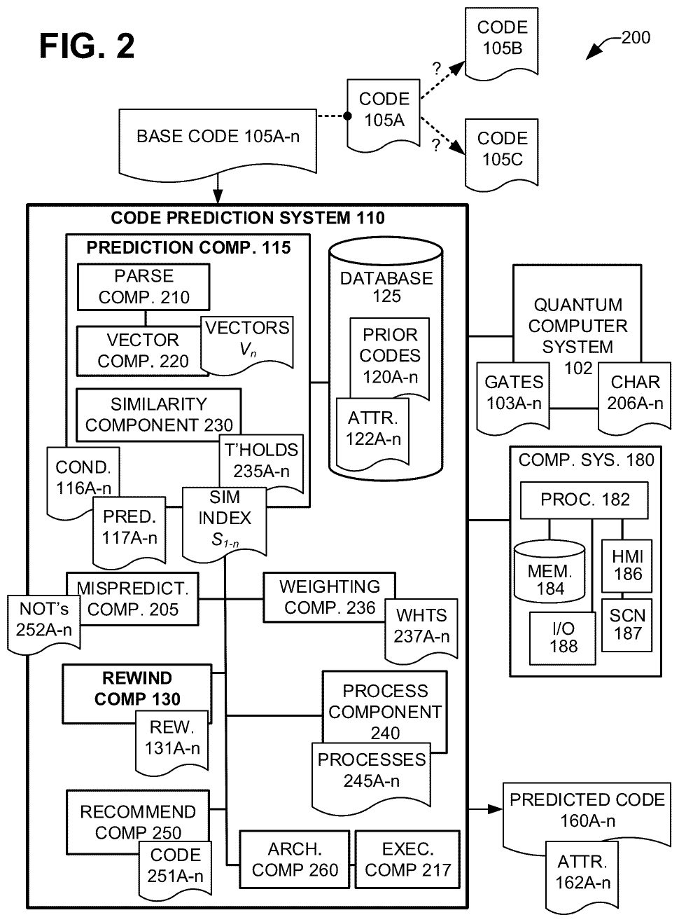

Turning to FIG. 2, system 200 further expands upon system 100 presented in FIG. 1. System 200 illustrates various components which can be utilized to predict/rewind a conditional operation, in accordance with one or more embodiments. As shown, and as previously described, CPS 110 can include a prediction component 115, database 125 configured to store/comprise prior codes 120A-n and attributes 122A-n, a rewind component 130, and a computer system 180, respectively communicatively coupled to CPS 110.

In an embodiment, the prediction component 115 can be configured to predict an outcome of an operational condition in a program code(s), e.g., base code 105A-n and prior codes 120A-n. In an embodiment, the prediction component 115 can include a parse component 210 configured to parse/identify the conditional operations 116A-n in the base code 105A-n. Prediction component 115 can further include a vector component 220 configured to convert text/numeric portions/content (e.g., high-level language) of the respective base code 105A-n and prior codes 120A-n into vectorized content (e.g., low-level language).

The parse component 210 can be configured to analyze base code 105A-n to determine/identify respective one or more portions of code included in the base code 105A-n pertaining to a conditional operation. It is to be appreciated that the term/phrase “portion of code” can describe a single line of code (e.g., a parameter and an associated value), through to multiple lines of program code. Hence, a block of code (e.g., base code 105A-n as received at CPS 110) may comprise of distinct/identifiable portions/segments of code, wherein each portion of code (e.g., code 105A, code 105B, code 105n) may have a separate topic/focus of functionality but the portions of code combine to create an overall set of instructions, e.g., base code 105A-n, for implementation on the quantum computer system 102.

The parse component 210 can be configured to parse a main code (e.g., base code 105A-n) to identify specific functions/functionality within the main code, such that the main code is broken down into portions of code 105A, 105B, 105n, etc., from the main code. Accordingly, the parse component 210 can be configured to identify distinct topics in base code 105A-n, enabling the portions of codes to be analyzed with a high degree of granularity. Hence, rather than a single body of code, e.g., base code 105A-n, being analyzed in its entirety for similarity with one or more prior codes 120A-n, base code 105A-n can be parsed to identify the specific features/content (e.g., code 105A, code 105B, code 105n) within the body of base code 105A-n for comparison with the prior codes 120A-n having a comparable level of granularity. Accordingly, the building blocks (portions of code) comprising base code 105A-n can be identified, e.g., regarding a memory address of code 105B called by code 105A.

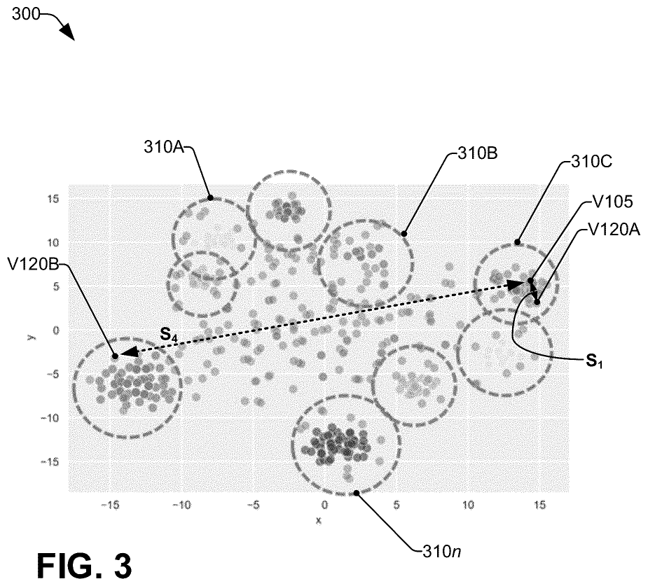

Prediction component 115 can further include a vector component 220 and a similarity component 230. Prediction component 115 can be configured to analyze the base code 105A-n and the prior codes 120A-n to identify one or more prior codes 120A-n and segments of base code 105A-n having a similarity ranging from a low degree of similarity (e.g., no match) through to a high degree of similarity (e.g., a match), and any intermediate degree of similarity therebetween. The vector component 220 can be configured to automatically process/vectorize the respective segments of base code 105A-n and prior codes 120A-n. As part of processing the respective portions of code in the codes 105 and 120A-n, each respective portion of code in each of the codes 105A-n and 120A-n can be defined/represented by the vector component 220 as a vector Vn, (e.g., where n represents segments of base code 105A-n, prior codes 120A-n, etc.) wherein the vector schema utilized can be any of a two-dimensional vector through to a multi-dimensional vector (e.g., a vector of many dimensions). Portions of code in both base code 105A-n and the prior codes 120A-n having a similar vector representation can form clusters when represented on a similarity plot (e.g., as further described with reference to FIG. 3). Accordingly, those portions of code having a common topic/purpose will likely have a similar multi-dimensional representation, thereby forming a cluster.

As shown in FIG. 2, prediction component 115 can further include a similarity component 230 configured to automatically determine a degree of similarity S (e.g., a similarity index S₁₋ₙ) between the base code segments 105A-n and one or more prior codes 120A-n which have been previously characterized with a prediction attribute 122A-n. In an example implementation, per FIG. 3, a similarity S₁₋ₙ can be assessed based on similarity/dissimilarity as identified based on distance between respective values of vectors Vn. Similarity component 230 can be configured to function with one or more thresholds 235A-n. For example, a threshold 235A has to be exceeded for an acceptable degree of similarity S to be inferred between base code segment 105A and a prior code 120A. In an embodiment, thresholds 235A-n can be established as a function of distance between two vectors, such that a distance S/indicates 95% similarity, a distance S₂ indicates 85% similarity, a distance S₃ indicates 75% similarity, a distance of S₄ or less indicates a similarity of less than 75% (with the similarity component 230 inferring that no similarity exists), and suchlike. It is to be appreciated that any suitable determination of similarity S can be utilized for the various embodiments presented herein.

Prediction component 115 can further include a weighting component 236 configured to automatically apply a weighting 237A-n to a prediction 117A-n to weight/skew the prediction 117A-n based on available knowledge regarding a specific segment of base code 105A-n and/or gate/qubit 103A-n of interest. The prediction component 115 can be configured to enable adjustment of a prediction 117A-n to be more or less likely (e.g., more likely to be taken, more likely to not be taken) based on a characteristic(s) 206A-n of the specific gate/qubit 103A-n of interest, e.g., as the gate/qubit 103A-n relates to a segment of code 105A-n. For example, if a qubit 103A-n has a characteristic high readout error, a weighting 237A-n can be applied to the prediction 117A-n, weighting the prediction 117A-n toward an erroneous measurement. Any suitable knowledge regarding characteristic 206A-n can be utilized by the weighting component 236, such as presence/likelihood of crosstalk at a gate/qubit 103A-n, influence of a state of a first qubit on the state of a second qubit (e.g., entanglement),

CPS 110 can include a program code execution component 217 configured to execute the respective base code segment 105A-n. In an embodiment, the execution component 217 can be included in CPS 110 or execution component 217 can be located external to CPS 110 (e.g., local to quantum computer system 102) with CPS 110 configured to monitor operation of/receive data regarding implementation base code 105A-n on quantum computer system 102, a quantum computer simulator, and suchlike.

CPS 110 can further include a misprediction component 205 configured to automatically determine whether a prediction 117A-n generated by prediction component 115 was correctly predicted or was a misprediction. In an embodiment, the misprediction component 205 can be configured to determine the outcome based on any of a gate operation at a quantum computer system 102, on a quantum simulator, an outcome of a running code on a classical computer system, and suchlike. In an aspect, implementation of the prediction component 115 and misprediction component 205 on the conditional statement 116A-n, and further generate a prediction 117A-n, based thereon, renders base code 105A-n to be predicted code 160A-n, wherein the prediction 117A-n associated with the predicted code 105A-n becomes attribute 162A-n of predicted code 160A-n.

In response to a determination by the misprediction component 205 that prediction 117A-n is correct (e.g., the predicted branch 105B, 105C, 105n, was utilized), the misprediction component 205 can be further configured to automatically generate and transmit a notification 252A-n indicating that prediction 117A-n was correct. Alternatively, misprediction component 205 can be further configured to automatically generate and transmit a notification 252A-n indicating that prediction 117A-n was incorrect (e.g., the predicted branch 105B, 105C, 105n, was not utilized).

CPS 110 can further include an archive component 260 configured to receive and process notification 252A-n. In response to receiving the prediction correct notification 252A-n, the archive component 260 can be further configured to archive the predicted code 160A-n (e.g., respective correct segment of base code 105A-n becomes respective predicted code 160A-n), the conditional operation 116A-n, the prediction 117A-n, and suchlike, in database 125, such that the predicted code 160A-n, the conditional operation 116A-n, the prediction 117A-n, and suchlike, are added to/supplement the prior codes 120A-n and attributes 122A-n. Accordingly, the knowledge gained by predicting the base code 105A-n as predicted code 160A-n can be utilized to predict/characterize a future base code 105A-n subsequently received at CPS 110. In another embodiment, in the event of a base code 105A-n is unable to be predicted with a sufficient degree of confidence (e.g., a particular threshold 235A-n of similarity was not met), the respective base code 105A-n can be archived and as the number of prior codes 120A-n in database 125 are further supplemented over time, the respective base code 105A-n can be re-evaluated based on the subsequent knowledge compiled in the prior codes 120A-n and associated attributes 122A-n. Hence, with prediction 117A-n being determined to be correct, the conditional operation 116A-n, the prediction 117A-n, and associated information, e.g., structure of quantum circuit 102, can be archived by archive component 260.

In response to a determination by the misprediction component 205 that prediction 117A-n was incorrect (e.g., the process flow from base code 105A utilized the unpredicted branch), as previously mentioned, the misprediction component 205 can be configured to further automatically generate and transmit a notification 252A-n indicating that prediction 117A-n was incorrect/a misprediction. In an embodiment, the misprediction notification 252A-n can be received by the archive component 260, whereupon the mispredicted code 105A-n, the conditional operation 116A-n, the prediction 117A-n, and suchlike, can be added to/supplement the prior codes 120A-n and attributes 122A-n in database 125 to supplement knowledge regarding current/future prediction of a conditional operation.

The rewind component 130 can also be configured to receive and process the notification 252A-n. In response to receiving notification 252A-n indicating the prediction 117A-n was incorrect, the rewind component 130, as previously mentioned, can be configured to implement the rewind operation 131A-n. The rewind operation 131A-n can be implemented by the rewind component 130 on any conditional operation and infrastructure affected by the prediction (e.g., a gate, a qubit, and suchlike) at a quantum computer system 102, on a quantum simulator, an outcome of a running code on a classical computer system, and suchlike.

In an embodiment, a reason for the prediction 117A-n being incorrect, such as reviewing the one or more processes 245A-n utilized in generating the prediction 117A-n (as further described). For example, knowledge regarding the incorrect prediction 117A-n can be utilized to train/fine-tune the one or more processes 245A-n to improve the probability of the respective process 245A-n generating a correct prediction 117A-n in the future.

The archive component 260 can be further configured to associate generate and transmit a notification 252A-n indicating a status of associating a prediction 117A-n with base code 105A-n. For example, a notification 252A can provide information regarding base code 105A-n, portions of code identified in base code 105A-n, predicted code 160A-n, one or more attributes 162A-n assigned to the predicted code 160A-n, prior codes 120A-n identified as being similar/sufficient similarity to the base code 105A-n/predicted code 160A-n, any information regarding similarity thresholds 235A-n being met/not met, whether it was not possible to characterize a base code 105A-n with an acceptable degree of certainty of similarity, respective vector values Vx for the base code 105A-n and prior codes 120A-n, determined degrees of similarity S₁₋ₙ, information regarding content/context of the base code 105A-n and prior codes 120A-n, any recommendations generated by a recommendation component (e.g., recommendation component 250, as further described) for utilization on the quantum computer system 102, any recommendations regarding improving the base code 105A-n with an existing prior code 120A-n (as described herein), what AI/ML processing (e.g., processes 245A-n) was applied to enable determination of prediction 117A-n, prediction weighting 237A-n, characteristic 206A-n determination, characterizing base code 105A-n, threshold 235A-n determination, identification of prior codes 120A-n and attributes 122A-n, identification of conditional operation 116A-n, determination of a rewind operation 131A-n, implementing replacement code 251A-n, determining attribute 162A-n, and suchlike. The notification 252A-n can be made available in any suitable manner, e.g., presented on a screen 187 of HMI 186, transmitted to an external entity (e.g., the owner of the base code 105, operator of quantum computer system 102, and suchlike) via the I/O 188.

CPS 110 can further include a recommendation component 250. In an embodiment, the recommendation component 250 can be configured with information (e.g., prediction etc.). In an embodiment, an intent/context of a base code 105A-n/predicted code 160A-n can be determined by the recommendation component 250, and based thereon, a replacement code 251A-n (e.g., in prior codes 120A-n) can be provided by the recommendation component 250, wherein the replacement code 251A-n can be configured to achieve the intent of the functionality as the base code segment 105A-n but achieves the functionality in a manner that will achieve a desired outcome of the base code segment 105A-n. For example, a creator of base code 105A may anticipate/require that in a particular condition of operation (e.g., in the event of a prior gate was taken, the conditional operation at gate 103A is expected to be taken. However, upon execution of the conditional operation 116A-n, gate 103A was not taken. In an embodiment, recommendation component 250 can be configured to automatically generate a replacement code 251A-n that achieves the required outcome. In an alternative embodiment, recommendation component 250 can be configured to automatically identify one or more portions of a quantum circuit in quantum computer system 102 to replace the one or more portions of the existing quantum circuit such that the desired outcome of conditional operation 116A-n for gate 103A-n is achieved.

In an embodiment, the recommendation component 250 can be configured to compile and generate a notification 252A-n for transmission to the entity generating base code 105A-n, such that the entity can utilize the replacement code, e.g., 251R, in a subsequent version of their base code 105A-n. In an embodiment, the replacement code 251R can be configured to perform a particular function on the quantum computer system 102, such that the recommendation component 250 can automatically identify a goal/endpoint of base code 105A-n, or portion 105A-n of base code 105, automatically identify that quantum computer system 102 can achieve the goal in a more efficient/improved manner, automatically identify the replacement code 251R that better achieves the goal, and replace base code 105A-n, or portion 105A-n of base code 105, with the replacement code 251R.

In another embodiment, the recommendation component 250 can automatically identify one or more components included in the quantum computer system 102, wherein the one or more components can be utilized to physically implement base code 105A-n at a subsequent time. In a further embodiment, the recommendation component 250 can be configured to automatically identify respective components currently included in the quantum computer system 102 and further identify one or more components required to implement the base code 105A-n. In the event of a component required to implement the base code 105A-n is not currently present/included in the quantum computer system 102, the recommendation component 250 can be configured to identify the required component (e.g., a modified qubit array) and further generate/transmit a notification 252A-n identifying the required component. The notification 252A-n can be received by any of the operator of the quantum computer system 102, the client providing base code 105 to the CPS 110, and suchlike, for further implementation of the required component, as required. Hence, the recommendation component 250 can be configured to extend knowledge regarding a prediction associated with base code 105A-n, and further determine whether the architecture, e.g., quantum computer system 102, can support implementation of a particular base code 105A-n.

As mentioned, CPS 110 can further comprise a process component 240 and processes 245A-n. It is to be appreciated that processes 245A-n can comprise any AI/ML model/technology/technique/architecture utilized to identify one or more prior codes 120A-n having content similar to the content of the base code 105A-n. The process component 240 can be utilized to implement processes 245A-n in conjunction with any of the other components included in CPS 110, e.g., the prediction component 115, the rewind component 130, misprediction component 205, the parse component 210, the vector component 220, the similarity component 230, the recommendation component 250, archive component 260, and suchlike.

It is to be appreciated that the various processes 245A-n and operations presented herein are simply examples of respective AI and ML operations and techniques, and any suitable technology can be utilized in accordance with the various embodiments presented herein. Processes 245A-n can be based on application of terms, codes, statements, etc., in the base code 105A-n and prior codes 120A-n, whereby processes 245A-n can include a vectoring technique such as bag of words (BOW) text vectors, and further, any suitable vectoring technology can be utilized by vector component 220, e.g., Euclidean distance, cosine similarity, etc. Other suitable AI/ML technologies that can be applied can include, in a non-limiting list, any of vector representation via term frequency-inverse document frequency (tf-idf) capturing term/token frequency in the base code 105A-n versus prior codes 120A-n, neural network embedding layer vector representation of terms/categories (e.g., common terms having different tense), a transformer neural network, bidirectional and auto-regressive transformer (BART) model architecture, a bidirectional encoder representation from transformers (BERT) model, long short term memory network (LSTM) operation(s), a sentence state LSTM (S-LSTM), a deep learning algorithm, a sequential neural network, a sequential neural network that enables persistent information, a recurrent neural network (RNN), a convolutional neural network (CNN), a neural network, capsule network, a machine learning algorithm, a natural language processing (NLP) technique, sentiment analysis, bidirectional LSTM (BILSTM), stacked BILSTM, breadth-first search (BFS), bounded BFS, depth-first search (DFS), and suchlike.

Accordingly, in an embodiment, implementation of the prediction component 115, parse component 210, the vector component 220, similarity component 230, weighting component 236, execution component 217, misprediction component 205, rewind component 130, process component 240, and suchlike, with processes 245A-n, enables NLP (e.g., utilizing vectors) to be implemented on base code 105A-n.

Language models, LSTMs, BARTs, etc., can be formed with a neural network that is highly complex, for example, comprising billions of weighted parameters. Training of the language models, etc., can be conducted, e.g., by process component 240, with datasets, whereby the datasets can be formed using any suitable technology, such as prior codes 120A-n, and suchlike. The prior codes 120A-n can be available from many sources, e.g., collected from prior code interactions with one or more customers/clients of the quantum computer system 102, provided by a client, provided by a third party (e.g., manufacturer/vendor of a component included in the quantum computer system 102), programmed by an engineer associated with operation of the quantum computer system 102, and suchlike. Further, base code 105A-n and prior codes 120A-n can comprise text, alphanumerics, numbers, single words, phrases, short statements, long statements, expressions, syntax, source code statements, machine code, etc. Fine-tuning of a LM can comprise application of a prior code 120A-n to the LM, the LM is correspondingly adjusted by application of the prior code 120A-n, such that, for example, weightings in the LM are adjusted by application of the prior code 120A-n.

As mentioned, portions of code in both base code 105A-n and the prior codes 120A-n having a similar vector representation can form clusters when represented on a similarity plot. FIG. 3, plot 300 illustrates clustering of respective vectors generated by vectorizing a base code 105A-n and prior codes 120A-n, in accordance with one or more embodiments. Plot 300 represents a two-dimensional plot of various vectors Vx and potential cluster formation, whereby vectors V120A-n are mathematical representations of the prior codes 120A-n, and vector V105 is a mathematical representation of a base code 105A. As shown in FIG. 3, the distance, e.g., similarity distance Sn, between respective vector values Vx indicates the degree of similarity between the codes 105A and 120A-n derived from the vectors V105 and V120A. Per the example schematic presented in FIG. 3, a similarity distance S₁ can be determined (e.g., by similarity component 230) between the value of vector V105 and vector V120A, and further, a similarity distance S₄ can be determined between the value of vector V105 and vector V120B. Hence, given that similarity distance S₁ is less than similarity distance S₄, an inference can be made (e.g., by similarity component 230) that the content of base code 105A has a high degree of similarity with the content of prior code 120A, while the content of base code 105A has a low degree of similarity with the content of prior code 120B. As previously mentioned, the degree of similarity between base code 105A and prior code 120A can be determined based on a threshold 235A reflecting a proximity of a first vector generated from base code 105A and a second vector generated from a prior code 120A-n.

The similarity component 230 can be configured to determine similarity based on text, semantics, textual summarization, etc., between various items of interest (e.g., pairings of base code 105A-n and respective prior codes 120A-n). To enable subsequent review of the base code 105A-n and prior codes 120A-n, clusters of vectors can be analyzed. Any suitable clustering technique (e.g., in processes 245A-n) can be utilized by the similarity component 230, e.g., vector quantization (VQ). In an embodiment, similarity component 230 can cluster the vectors V120A-n and V105 based on their respective vector representation. For example, a k-means clustering algorithm, such as a radius-based k-means clustering algorithm, can be applied by the similarity component 230 to cluster the vectors V120A-n and V105 into clusters comprising vectors that have the same, similar, or approximate value. Hence vectors in cluster 310A represent codes (e.g., codes 105A and 120A-n) having similar functionality/content, and similarly clusters 310B, 310C, and 310n comprise codes having respectively similar functionality/content.

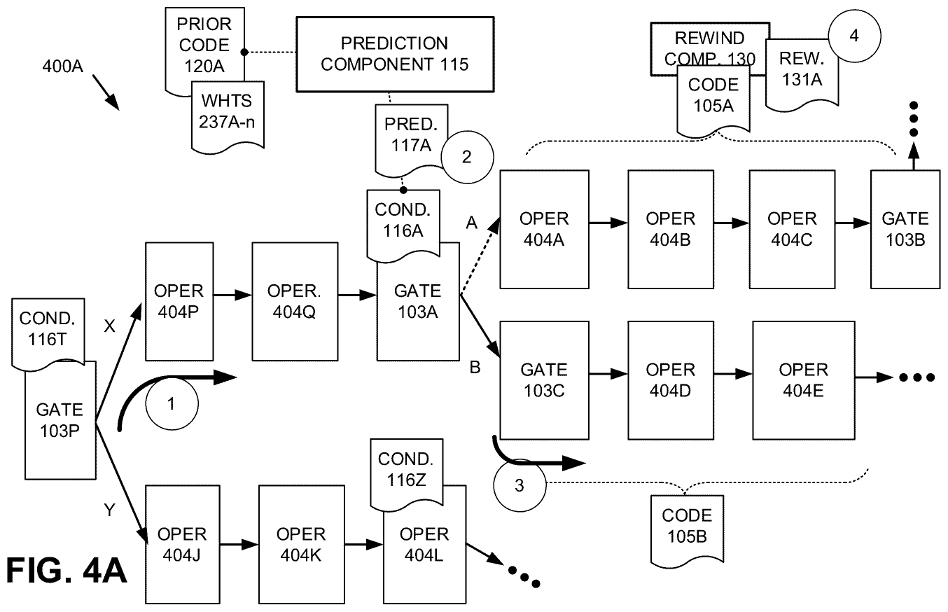

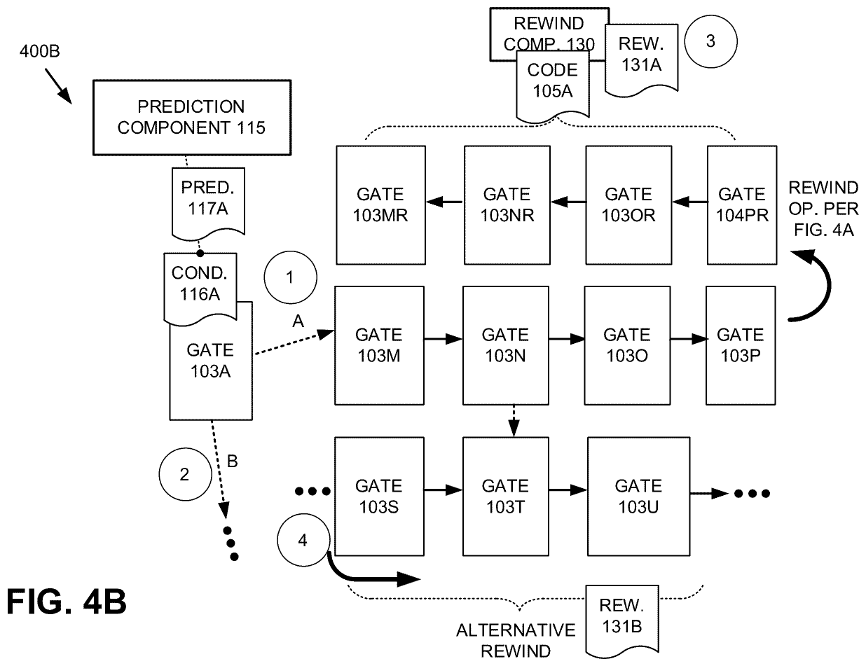

FIG. 4A presents a schematic 400A illustrating a prediction being made and a rewind operation being compiled, in accordance with an embodiment.

Schematic 400A presents a representation of a quantum circuit (e.g., in quantum computer system 102) in conjunction with base code 105A-n being implemented on the quantum circuit. Accordingly, schematic 400A presents an arrangement of gates 103A-n (wherein various gates 103A-n can have an associated conditional operation 116A-n) in conjunction with various operations 404A-n that can be performed at a gate 103A-n as well as an operation to be performed by another device/component included in/associated with the quantum circuit. As shown, gate 103P can be a conditional gate with conditional operation 116T, with branches X and Y available, branch Y comprises operations 404J-L, etc., while branch X comprises operations 404P-Q and gate 103A with conditional operation 116A. The conditional operation 116T has already been executed, with branch X selected/taken.

Schematic 400A further includes gate 103A having a conditional operation 116A with branches A and B available, branch A comprises code segment 105A including operations 404A-C, gate 103B, etc., while branch B comprises code segment 105B including gate 103C and operations 404D-E. As previously described, prediction component 115 can be configured to generate a prediction 117A regarding an outcome of conditional operation 116A and whether code 105A, branch A, will be selected/taken or code 105B, branch B, will be selected/taken. As further previously described, rewind component 130 can monitor operations executed/performed on a respective branch code 105A and code 105B to compile a rewind operation/code 131A.

Hence, per the example scenario presented in FIG. 4A, at 400A-(1) the conditional operation 116T at gate 103P resulted in branch X being selected/taken.

At 400A-(2), prediction component 115 generates a prediction 117A that after execution of the conditional operation 116A at gate 103A, branch A will be selected/taken, for operations, states, etc., pertaining to code 105A have already been precompiled. In an embodiment, prediction component 115 selects branch A as the potentially more probable option as a function of how a similar circuit/code represented in prior code 120A performed. Weightings 237A-n can also be utilized as part of generating the prediction 117A.

At 400A-(3), upon execution of the conditional operation 116A, branch B pertaining to code 105B is selected/taken which is contrary to the branch A, code 105A, predicted in prediction 117A, whereby branch A, code 105A, is not taken.

At 400A-(4), rewind component 130 can have a rewind operation 131A precompiled as a function of the operations, states, etc., resulting from the speculative execution of code 105A and operations 404A-C/gate 103B, such that the rewind operation 131A can be applied to the functions/states of operations 404A-C/gate 103B, with rewind operation 131A functioning as a complimentary (e.g., as a conjugate transpose). Hence, with the rewind operation 131A being applied, the functions performed at operations 404A-n and gate 103B (e.g., as a function of incorrectly applying code 105A as branch A was not taken) can be returned to a condition prior to execution of the conditional operation 116A.

FIG. 4B presents a schematic 400B illustrating a prediction being made and a rewind operation being compiled, in accordance with an embodiment.

As previously described with reference to FIG. 4A, in an embodiment, a rewind component 130 can be configured to monitor operations performed/executed on a branch (e.g., branch A, branch B, etc.), and in response to a misprediction by the prediction component 115, the rewind component 130 can implement a rewind operation 131A-n.

Accordingly, the rewind operation presented in FIG. 4A can be represented as:

```
If (something/event)
  A B C D
Else
  E F G H
```

wherein E F G H represent the rewind operation 131A-n (e.g., compliment/conjugate transpose) of elements A B C D (e.g., gates/operations), whereby A B C D E F G H can represent respective gates 103A-n and/or operations 404A-n. Hence, the misprediction operation sequence represented in FIG. 4A can be represented as:
A B C D (misprediction)→E F G H (rewind).

In a further embodiment, rewind component 130 can be configured to identify/find a path over a series of basis gates (and/or operations) that can achieve the same operational state as utilizing a rewind operation 131A-n. Per the presented example, at compile time (e.g., when prediction 117A is performed), a bounded breadth-first search operation (bounded BFS) can be utilized by the rewind component 130 to identify an operation that can achieve the same state as after (A B C D) have been implemented. In an embodiment, the rewind component 130 can review the quantum circuit in computing system 102, identify a sequence of gates X Y Z (e.g., gates 103X-103Y) having the same resulting state as if the rewind sequence DC B A E F G H had been implemented. Hence, rather than rewind component 130 implementing the E F G H rewind operation, the same state can be achieved by the rewind component 130 implementing gates X Y Z. In an aspect, implementing the bounded BFS X Y Z sequence may utilize less gates than performing the rewind operation presented in FIG. 4A, which can be useful when operating in a noisy quantum system.

FIG. 4B (based on FIG. 4A), presents an example of the further embodiment:

At 400B-(1) the conditional operation 116T at gate 103A resulted in branch A being predicted in prediction 117A by the prediction component 115. Branch A comprises a sequence of four gates 103M-P. At the time of the Branch A prediction 117A, the operations, states, etc., pertaining to code 105A have already been precompiled, e.g., for the four gates 103M-P.

At 400B-(2), upon execution of the conditional operation 116A, a different branch (e.g., branch B pertaining to code 105B, per FIG. 4A) is selected, which is contrary to the branch A, code 105A, predicted in prediction 117A, such that branch B was taken and branch A was not taken.

At 400B-(3), as described in FIG. 4A, rewind component 130 can have a rewind operation 131A precompiled as a function of the operations, states, etc., resulting from the speculative execution of code 105A. Hence, the predicted sequence 103-M, 103N, 1030, and 103P, are undone by the rewind component 130 implementing the rewind operation 131A comprising compliment operations 103-PRewind, 103OR, 103NR and 103MR.

However, at 400B-(4) the rewind component 130 has identified gates 103S, 103T, and 103U can have the same effect as applying the operations at 103PR, 103OR, 103NR, and 103MR. Hence, with the alternate rewind operation 131B being applied, the functions performed at gates 103S-U can return the quantum circuit 102 to a condition prior to the mispredicted execution of the conditional operation 116A.

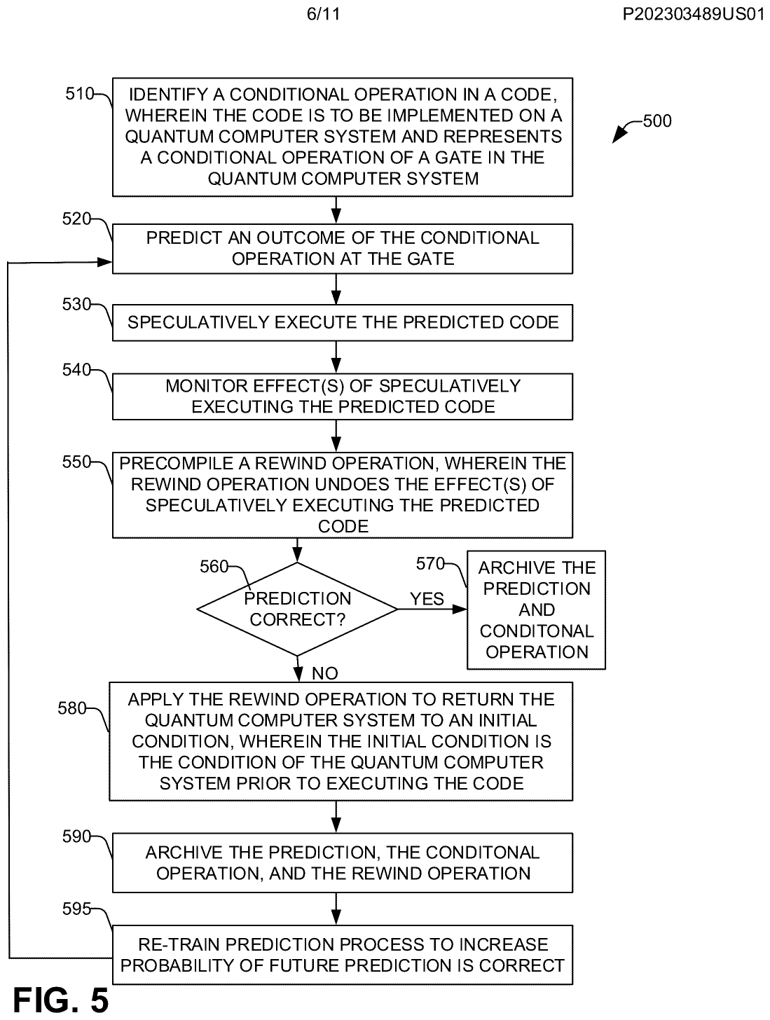

FIG. 5, process 500, illustrates a computer-implemented process for predicting an outcome of a conditional operation performed on a quantum computer system, and functions pertaining thereto, according to one or more embodiments.

At 510, program code (e.g., base code 105A-n) for implementation on a quantum circuit of a quantum computer system (e.g., quantum computer system 102) can be received at a code prediction system (e.g., CPS 110), wherein the program code has not been previously characterized, and furthermore, the program code has not been implemented on a quantum computer system. Accordingly, knowledge of the content, functionality, etc., of the program code may be currently limited. In an embodiment, the program code can be parsed (e.g., by parse component 210) to identify respective segments of the base code (e.g., code segments 105A, 105B, 105n) and any conditional operations associated therewith (e.g., conditional operation 116A-n), wherein the conditional operation can be associated with operation of a gate, a qubit, etc. (e.g., gate 103A-n).

At 520, a prediction (e.g., prediction 117A-n) can be generated (e.g., by prediction component 115) regarding an outcome of the conditional operation. For example, a prediction is made that a first branch (e.g., first program code including code 105A and gates/qubits/operations/architecture associated therewith) has a higher probability of being implemented than a probability of a second branch (e.g., second program code including code 105B and gates/qubits/operations/architecture associated therewith).

At 530, operations, etc., at the first branch comprising the first program code can be speculatively executed (e.g., by execution component 217) in conjunction with execution of the conditional operation (e.g., conditional operation 116A-n presented in FIG. 4).

At 540, in an embodiment, while the conditional operation is being executed, one or more functions generated during execution of the first program code on the first branch can be monitored by a rewind component (e.g., by rewind component 130).

At 550, the rewind component can be configured to compile a rewind operation (e.g., rewind operation 131A-n) which compliments the one or more functions generated during execution of the first program code on the first branch. In another embodiment, the one or more functions generated by execution of the first program code can be pre-known to the rewind component, e.g., from a previous execution of the first program code (e.g., in prior codes 120A-n), such that the rewind component can compile the rewind operation based on the previously known/observed implementation of code/components having comparable/similar functionality to the program code.

At 560, a determination can be made by a misprediction component (e.g., misprediction component 205) regarding whether execution of the conditional operation caused the first program code to be implemented (e.g., prediction was correct, first branch/code 105A was taken, second branch/code 105B was not taken), or the prediction was incorrect, and the conditional operation caused the second program code to be implemented (e.g., prediction was incorrect, first branch/code 105A was not taken, second branch/code 105B was taken)). In response to a determination by the misprediction component that YES, the prediction correctly predicted the first program code being executed, process 500 can advance to step 570, whereupon information/metadata pertaining to any of the conditional operation, the prediction, the first code, and suchlike can be stored/archived as historical data (e.g., as predicted code 160A and attribute 162A as an addition to prior codes 120A-n/attribute 122A-n) for subsequent use when a subsequent prediction is conducted.

At 560, in response to a determination by the misdirection component that NO, the prediction did not match the result of executing the conditional operation, the prediction was incorrect, process 500 can advance to step 580, whereupon the rewind operation (e.g. rewind operation 131A-n) can be applied by the rewind component to return the respective states/components/conditions affected by application of the mispredicted first code to a respective condition prior to speculative execution of the first code being performed. In an embodiment, the rewind operation can be a compliment, a conjugate transform, and suchlike, of the one or more effects of speculatively implementing the first code. Process 500 can further advance to 590 whereupon information/metadata pertaining to the mispredicted first code and associated operation(s) can be archived, e.g., the conditional operation, the prediction, the rewind operation, gate(s)/qubit(s) affected by the mispredicted first code, and suchlike.

At 595, the one or more processes (e.g., processes 245A-n) utilized in the prediction process (e.g., at step 520) can be archived (e.g., as attribute/historical data 120A-n in database 125/memory 184) and can be further trained/fine-tuned based on knowledge acquired/derived from the misprediction. Process 500 can further return to step 520 for the prediction process to be repeated, e.g., to determine whether the subsequent prediction is correctly performed as a function of the knowledge acquired/derived during the previous prediction.

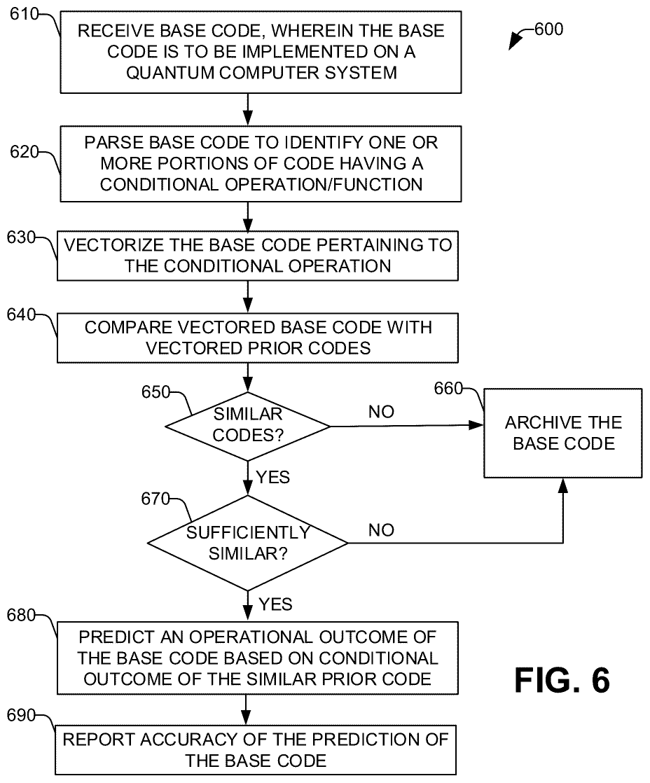

FIG. 6, process 600, illustrates a computer-implemented process for predicting implementation of a program code based on a pre-existing code, according to one or more embodiments.

At 610, a first code (e.g., base code 105A) is received at a code prediction system (e.g., CPS 110), wherein the first code includes a conditional operation, the outcome of which is currently unknown. The first code has been configured to be implemented on a quantum computer system (e.g., quantum computer system 102).

At 620, the first code can be parsed (e.g., by parse component 210) to identify one or more conditional operations included in the first code.

At 630, the first code can be vectorized (e.g., by vector component 220) to facilitate identification of a conditional operation in the first code with one or more conditional operations in a collection of prior codes (e.g., prior codes 120A-n), wherein the prior codes can include respective conditional operations that have been previously characterized/predicted and one or more attributes (e.g., attributes 122A-n) respectively identified for each of the prior codes, e.g., wherein the one or more attributes indicate a first outcome, a second outcome, and suchlike. The first code and prior codes can be in a format to enable the respective codes to be vectorized to enable similarity assessment to be conducted. Further, the first code and the prior codes can be portions of a larger code, e.g., first code has been extracted from a larger code (e.g., base code 105A-n) that was originally submitted to the code prediction system.

At 640, the vectored first code is compared by a similarity component (e.g., similarity component 230) with vectored prior codes.

At 650, a determination can be made by the similarity component regarding whether content of one or more prior codes are similar to the content of the first code. In response to a determination by the similarity component that NO prior codes exist that have similar content to that of the first code, process 600 can advance to step 660, whereupon the first code can be archived (e.g., added to the prior codes) for subsequent review, such as a subsequent prediction process performed as knowledge at the code prediction system improves (e.g., further program codes having conditional operations are received, processes 245A-n are trained/finetune in view of conditional operation 116A-n not being identified in the prior codes, and suchlike).

At 650, in response to a determination by the similarity component that YES, a second code in the collection of prior codes has been identified that may be similar to the first code (e.g., content of the second code is comparable to first code with regard to conditional operation, functionality, coding, etc.), process 600 can advance to step 670.

At 670, the degree of similarity between the first code and the second code (and further other similar codes) in the collection of prior codes can be assessed by a similarity component (e.g., similarity component 230), wherein the similarity component can utilize similarity thresholds (e.g., similarity thresholds 235A-n) to determine whether a similarity (e.g., similarity Sn) determined between a second, pre-existing code has sufficient similarity to the first code to enable predicting a conditional outcome of the first code with a known conditional outcome of the identified second, pre-existing code. In the event of a determination by the similarity component of NO, insufficient similarity exists (e.g., Sₙ<threshold 235A) between the first code and the second code (or any other identified pre-existing code(s)), e.g., a required threshold of similarity was not met, process 600 can return to step 660, whereupon the first code can be archived, as previously mentioned.

At 670, in the event of a determination by the similarity component that YES, a threshold of similarity was met (e.g., Sₙ≥threshold 235A), process 600 can advance to step 680, whereupon the prediction component can be further configured to apply the conditional outcome (e.g., in attributes 122A-n) determined for the second code as a predictive outcome of the conditional operation of the first code.

At 680, the outcome of the prediction for the first code can be assessed by a misprediction component (e.g., by misprediction component 205), whereby the prediction can be assessed as correct or incorrect, as previously described.

At 690, the misprediction component can be further configured to generate and transmit a notification (e.g., notification 252A-n) regarding any of the accuracy of the prediction, conditional operation(s) identified in either of the first code or the second code, prior codes identified as being similar/sufficient similarity to the first code, any information regarding similarity thresholds being met/not met, whether it was not possible to characterize the first code with an acceptable degree of certainty of similarity, respective vector values Vx for the first code and prior codes, determined degrees of similarity S₁₋ₙ, information regarding formatting of the first code and prior codes, any recommendations generated by a recommendation component (e.g., recommendation component 250) for utilization on the quantum computer system, any recommendations regarding improving the first code with an existing prior code, what AI/ML processing (e.g., processes 245A-n) was applied in predicting an outcome of the first code, and suchlike.

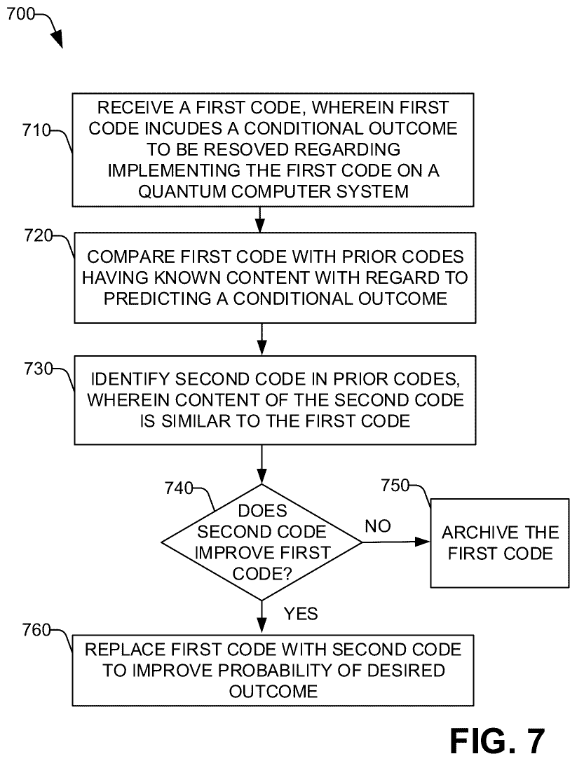

FIG. 7, process 700, illustrates a computer-implemented process for potentially improving a base code based on a pre-existing code characterized for implementation on a quantum computer system, according to one or more embodiments.

At 710, a first code (e.g., base code 105A) is received at a code prediction system (e.g., CPS 110), wherein the first code includes a conditional outcome (e.g., conditional operation 116A-n) for which a prediction (e.g., prediction 117A-n) is to be generated. The first code has been configured to be implemented on a quantum computer system (e.g., quantum computer system 102).

At 720, as part of a prediction process (e.g., by prediction component 115, execution component 217, and suchlike), the first code can be compared with a collection of prior codes (e.g., prior codes 120A-n), wherein the prior codes have been previously characterized and one or more attributes (e.g., attributes 122A-n) respectively identified for each of the prior codes with regard to a determined prediction for a conditional operation.

At 730, a second code, in the collection of prior codes, is identified as being sufficiently similar to the first code, e.g., content of the second code is comparable to first code with regard to functionality, coding, etc.

At 740, a determination can be made regarding whether the second code increases a probability of a conditional operation occurring in accordance with a desired prediction. For example, with the conditional operation having a known outcome in the second code, does the second code have a higher probability of the desired outcome of the conditional operation being achieved over the coding/structure of the first code? (e.g., operation of a sequence of quantum gates, and suchlike), does the second code achieve the desired outcome in a more efficient manner? In response to a determination (e.g., by recommendation component 250) that NO, the second code does not improve on the first code, process 700 can advance to step 750, whereupon the first code in its current form can be stored in combination with the assigned attribute (e.g., in database 125).

At 740, in response to a determination (e.g., by recommendation component 250) that YES, the second code is better configured to achieve the desired outcome, process 700 can advance to step 760, wherein the first code can be replaced by/supplemented (e.g., by recommendation component 250) by the second code, whereupon the amended first code can be stored (e.g., in database 125).

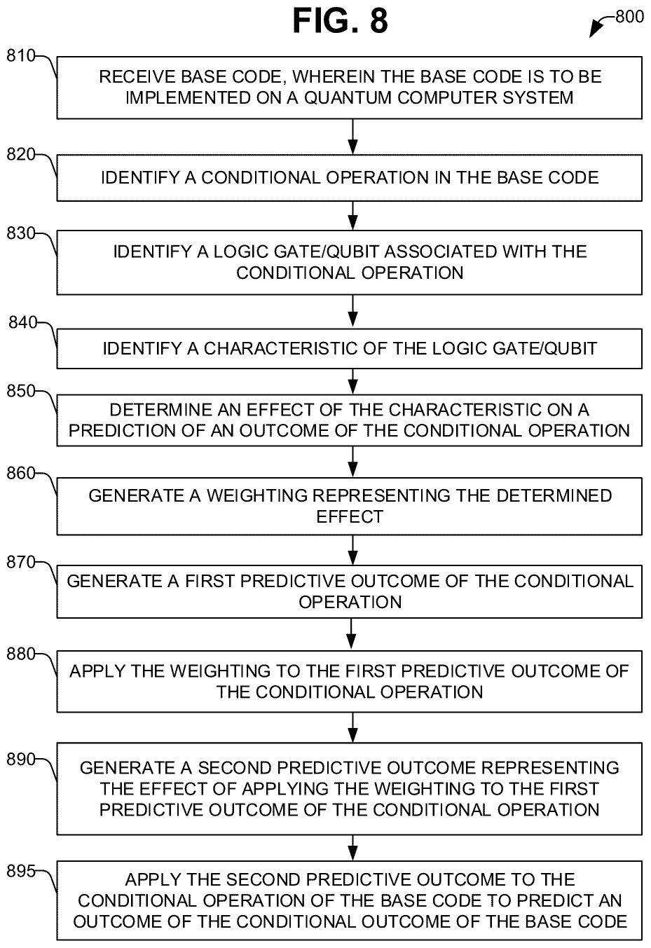

FIG. 8, process 800, illustrates a computer-implemented process for adjusting a prediction of a conditional outcome based on one or more characteristics present at a system architecture, according to one or more embodiments.

At 810, a base code (e.g., base code 105A) can be received a code prediction system (e.g., CPS 110), wherein the base code includes a conditional operation, the outcome of which is currently unknown. The base code has been configured to be implemented on a quantum computer system (e.g., quantum computer system 102).

At 820, the base code can be parsed by a parse component (e.g., parse component 210) configured to identify a conditional operation (e.g., conditional operation 116A-n) included in the base code.

At 830, system architecture (e.g., a qubit, a logic gate 103A-n, and suchlike) associated with the condition operation can be identified by a prediction component (e.g., prediction component 115). In an embodiment, the system architecture can be a qubit (e.g., qubit 103A) which has a potential first outcome (e.g., code 105B) and a potential second outcome (e.g., code 105C).

At 840, an operational characteristic (e.g., characteristic 206A) of the system architecture can be identified by a weighting component (e.g., weighting component 236). For example, the characteristic can be a crosstalk effect can be present at the qubit, interference leading to decoherence of the qubit, and suchlike.

At 850, the weighting component can be further configured to determine an effect of the characteristic on a prediction (e.g., prediction 117A) associated with the conditional outcome.

At 860, the weighting component can be further configured to generate a weighting (e.g., weighting 237A) representing the determined effect of the characteristic on the prediction. For example, the qubit has a high readout error, a weighting can be applied to a prediction, which can weight the prediction toward an erroneous measurement.

At 870, a first predictive outcome (e.g., prediction 117A) of the conditional operation can be generated by a prediction component (e.g., prediction component 115).

At 880, the weighting component can be further configured to apply the weighting to the first predictive outcome.

At 890, the first predictive outcome can be updated (e.g., by the prediction component 115) to generate a second predictive outcome (e.g., prediction 117B), wherein the second predictive outcome represents the effect of applying the weighting to the first predictive outcome.

At 895, the second predictive outcome can be applied to the base code to predict an outcome of the conditional operation of the base code, as previously described.

Per the various embodiments presented herein, various components included in CPS 110, prediction component 115, parse component 210, vector component 220, rewind component 130, similarity component 230, recommendation component 250, archive component 260, process component 240, and suchlike, can include AI and ML and reasoning techniques and technologies (e.g., processes 245A-n) that employ probabilistic and/or statistical-based analysis to prognose or infer an action that a user desires to be automatically performed, as previously mentioned. The various embodiments presented herein can utilize various AI and ML-based schemes for carrying out various aspects thereof. For example, a process 245A (e.g., by rewind component 130 in conjunction with similarity component 230) for characterizing a base code 105A-n with one or more prior codes 120A-n, a process 245B (e.g., by recommendation component 250) to determine codes and equipment to implement base code 105A-n, and suchlike, as previously mentioned herein, can be facilitated via an automatic classifier system and process.

A classifier is a function that maps an input attribute vector, x=(x1, x2, x3, x4, xn), to a class label class (x). The classifier can also output a confidence that the input belongs to a class, that is, f (x)=confidence (class (x)). Such classification can employ a probabilistic and/or statistical-based analysis (e.g., factoring into the analysis utilities and costs) to prognose or infer an action that a user desires to be automatically performed (e.g., predicting an outcome of a conditional operation 116A-n, executing a rewind operation 131A-n, and operations related thereto).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to predicting an outcome of a conditional operation 116A-n, executing a rewind operation 131A-n, for example.

As described supra, inferences can be made, and automated operations performed, based on numerous pieces of information. For example, whether a prior code 120A-n and associated attribute 122A-n has similar coding structure, functionality, etc., as base code 105A-n, and accordingly, a prediction 117A-n of a conditional operation 116A-n for base code 105A-n can be based on a prior code 120A-n, implementing a rewind operation 131A-n to undo a speculative execution of a base code 105A, etc.

### Example Applications and Use

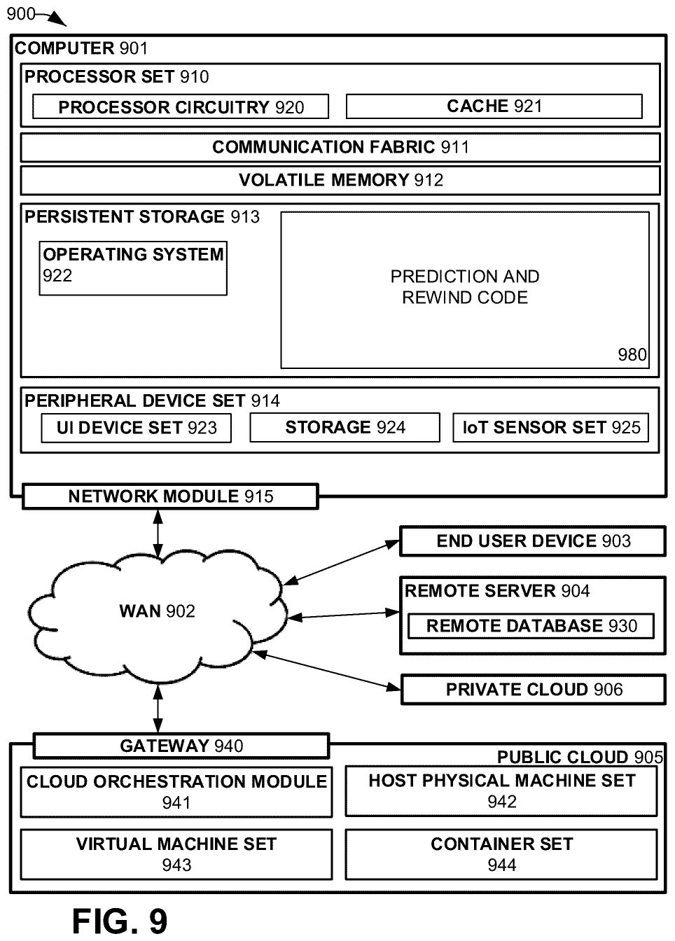

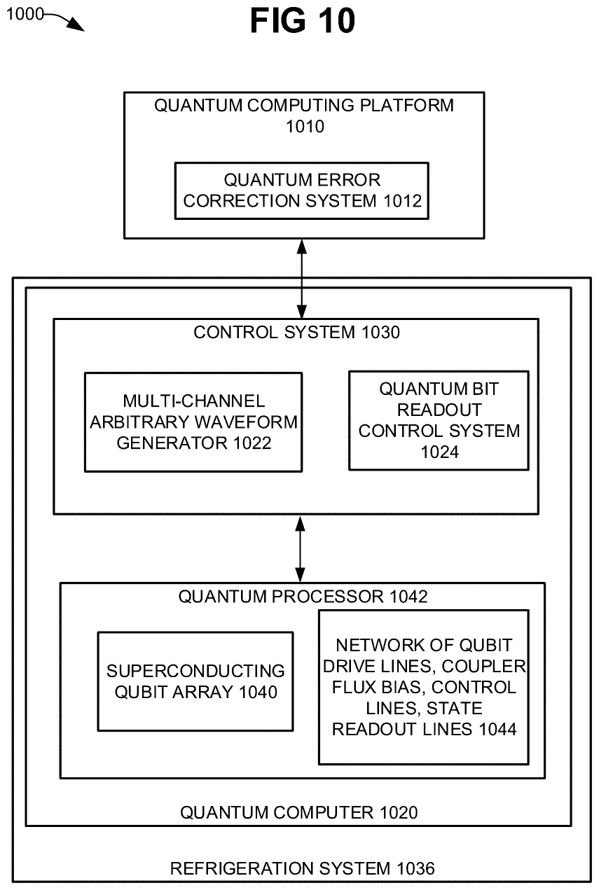

FIGS. 9 and 10 and the following discussion are intended to provide a brief, general description of a suitable computing environments 900 and 1000 in which one or more embodiments described herein at FIGS. 1-8 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code involved in performing the inventive methods, such as automatically generating a prediction (e.g., prediction 117A-n) for a conditional operation (e.g., conditional operation 116A-n) for a base code (e.g., base code 105A-n), via the application of prediction and rewind code 980 (e.g., having the functionality of one or more components of code prediction system/CPS 110), wherein in the event of an incorrect prediction being made, a rewind operation 131A-n can be employed by a rewind component 130 to undo effects of a speculative execution of the base code 105A-n as a function of the incorrect prediction. In addition to block 980, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 980, as identified above), peripheral device set 914 (including user interface (UI), device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method can be distributed among multiple computers and/or between multiple locations. On the other hand, in this presentation of computing environment 900, detailed discussion is focused on a single computer, specifically computer 901, to keep the presentation as simple as possible. Computer 901 can be located in a cloud, even though it is not shown in a cloud in FIG. 9. On the other hand, computer 901 is not required to be in a cloud except to any extent as can be affirmatively indicated.

PROCESSOR SET 910 includes one, or more, computer processors of any type now known or to be developed in the future. Processing circuitry 920 can be distributed over multiple packages, for example, multiple, coordinated integrated circuit chips. Processing circuitry 920 can implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set can be located “off chip.” In some computing environments, processor set 910 can be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods can be stored in block 980 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory can be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 can be a read only memory (ROM), but typically at least a portion of the persistent storage allows writing of data, deletion of data and re-writing of data. Some familiar forms of persistent storage include magnetic disks and solid-state storage devices. Operating system 922 can take several forms, such as various known proprietary operating systems or open-source Portable Operating System Interface type operating systems that employ a kernel. The code included in block 980 typically includes at least some of the computer code involved in performing the inventive methods.

PERIPHERAL DEVICE SET 914 includes the set of peripheral devices of computer 901. Data communication connections between the peripheral devices and the other components of computer 901 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 923 can include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 can be persistent and/or volatile. In some embodiments, storage 924 can take the form of a quantum computing storage device for storing data in the form of qubits. In embodiments where computer 901 is required to have a large amount of storage (for example, where computer 901 locally stores and manages a large database) then this storage can be provided by peripheral storage devices designed for storing large amounts of data, such as a storage area network (SAN) that is shared by multiple, geographically distributed computers. IoT sensor set 925 is made up of sensors that can be used in Internet of Things applications. For example, one sensor can be a thermometer and another sensor can be a motion detector.

NETWORK MODULE 915 is the collection of computer software, hardware, and firmware that allows computer 901 to communicate with other computers through WAN 902. Network module 915 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901) and can take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 can be a client device, such as thin client, heavy client, mainframe computer and/or desktop computer.

REMOTE SERVER 904 is any computer system that serves at least some data and/or functionality to computer 901. Remote server 904 can be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data can be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs can be stored as images and can be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware and firmware allowing public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the Figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system”, “platform”, and/or “interface”, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store”, “storage”, “data store”, “data storage”, “database”, and substantially any other information storage component relevant to operation and functionality of a component are utilized to refer to “memory components”, entities embodied in a “memory”, or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

FIG. 10, presents a quantum computer system 1000, according to at least one embodiment, wherein computing system 1000 can comprise/be incorporated into quantum computer system 102. FIG. 10 schematically illustrates the quantum computing system 1000 which comprises a quantum computing platform 1010, a control system 1030, and a quantum processor 1042. In various embodiments, the quantum computing platform 1010 implements software control programs such as a software-based quantum error correction system 1012 to perform a quantum error correction processes, application of source code, etc., as well as perform other software-controlled processes such as qubit calibration operations. In other embodiments, the control system 1030 comprises a multi-channel arbitrary waveform generator 1022, and a quantum bit readout control system 1024. A quantum processor 1042 can comprise one or more solid-state semiconductor chips having one or more qubit arrays 1040 located thereon, and further a network 1044 of qubit drive lines, coupler flux-bias control lines, and qubit state readout lines, and other circuit QED components that may be needed for a given application or quantum system configuration.

In various embodiments, the control system 1030 and the quantum processor 1042 can be disposed in a dilution refrigeration system 1036 which can generate cryogenic temperatures that are sufficient to operate components of the control system 1030 for quantum computing applications. For example, the quantum processor 1042 may need to be cooled down to near-absolute zero, e.g., 10-15 millikelvin (mK), to allow the superconducting qubits to exhibit quantum behaviors. In some embodiments, the dilution refrigeration system 1036 comprises a multi-stage dilution refrigerator where the components of the control system 1030 can be maintained at different cryogenic temperatures, as needed. For example, while the quantum processor 1042 may need to be cooled down to, e.g., 10-15 mK, the circuit components of the control system 1030 may be operated at cryogenic temperatures greater than 10-15 mK (e.g., cryogenic temperatures in a range of 3K-4K), depending on the configuration of the quantum computing system.

In other embodiments, the qubit array 1040 comprises a quantum system of data/auxiliary qubits and qubit couplers. The number of qubits of the qubit array 1040 can be on the order of tens, hundreds, thousands, or more, etc. The network 1044 of qubit drive lines, coupler flux bias control lines, and qubit state readout lines, etc., are configured to apply microwave control signals to qubits and coupler circuitry in the qubit array 1040 to perform various types of gate operations, e.g., single-gate operations, entanglement gate operations (e.g., CPHASE gate operation), perform error correction operations, etc., as well read the quantum states of the qubits. For example, as noted above, microwave control pulses are applied to the qubit drive lines of respective qubits to change the quantum state of the qubits (e.g., change the quantum state of a given qubit between the ground state and excited state, or to a superposition state) when executing quantum information processing algorithms.

Furthermore, as noted above, the state readout lines comprise readout resonators that are coupled to respective qubits. The state of a given qubit can be determined through microwave transmission measurements made between readout ports of the readout resonator. The states of the qubits are read out after executing a quantum algorithm. In some embodiments, a dispersive readout operation is performed in which a change in the resonant frequency of a given readout resonator, which is coupled to a given qubit, is utilized to readout the state (e.g., ground or excited state) of the given qubit.

The network 1044 of qubit drive lines, coupler flux bias control lines, and qubit state readout lines, etc., is coupled to the control system 1030 through a suitable hardware input/output (I/O) interface, which couples I/O signals between the control system 1030 and the quantum processor 1042. For example, the hardware I/O interface may comprise various types of hardware and components, such as RF cables, wiring, RF elements, optical fibers, heat exchanges, filters, amplifiers, isolators, etc.

In some embodiments, the multi-channel arbitrary waveform generator (AWG) 1022 and other suitable microwave pulse signal generators are configured to generate the microwave control pulses that are applied to the qubit drive lines, and the coupler drive lines to control the operation of the superconducting qubits and associated qubit coupler circuitry, when performing various gate operations to execute a given certain quantum information processing algorithm. In some embodiments, the multi-channel AWG 1022 comprises a plurality of AWG channels, which control respective superconducting qubits within the superconducting qubit array 1040 of the quantum processor 1042. In some embodiments, each AWG channel comprises a baseband signal generator, a digital-to-analog converter (DAC) stage, a filter stage, a modulation stage, an impedance matching network, and a phase-locked loop system to generate local oscillator (LO) signals (e.g., quadrature LO signals LO_I and LO_Q) for the respective modulation stages of the respective AWG channels.

In some embodiments, the multi-channel AWG 1022 comprises a quadrature AWG system which is configured to process quadrature signals, wherein a quadrature signal comprises an in-phase (I) signal component, and a quadrature-phase (Q) signal component. In each AWG channel the baseband signal generator is configured to receive baseband data as input (e.g., from the quantum computing platform), and generate digital quadrature signals I and Q which represent the input baseband data. In this process, the baseband data that is input to the baseband signal generator for a given AWG channel is separated into two orthogonal digital components including an in-phase (I) baseband component and a quadrature-phase (Q) baseband component. The baseband signal generator for the given AWG channel can generate the requisite digital quadrature baseband IQ signals which are needed to generate an analog waveform (e.g., sinusoidal voltage waveform) with a target center frequency that is configured to operate or otherwise control a given quantum bit that is coupled to the output of the given AWG channel.

The DAC stage for the given AWG channel is configured to convert a digital baseband signal (e.g., a digital IQ signal output from the baseband signal generator) to an analog baseband signal (e.g., analog baseband signals I (t) and Q (t)) having a baseband frequency. The filter stage for the given AWG channel is configured to filter the IQ analog signal components output from the DAC stage to thereby generate filtered analog IQ signals. The modulation stage for the given AWG channel is configured to perform analog IQ signal modulation (e.g., single-sideband (SSB) modulation) by mixing the filtered analog signals I (t) and Q (t), which are output from the filter stage, with quadrature LO signals (e.g., an in-phase LO signal (LO_I) and a quadrature-phase LO signal (LO_Q)) to generate and output an analog RF signal (e.g., a single-sideband modulated RF output signal).

In some embodiments, the quantum bit readout control system 1024 comprises a microwave pulse signal generator that is configured to apply a microwave tone to a given readout resonator line of a given qubit to perform a readout operation to readout the state of the given qubit, as well as circuitry that is configured to process the readout signal generated by the readout resonator line to determine the state of the given qubit, using techniques known to those of ordinary skill in the art.

The quantum computing platform 1010 comprises a software and hardware platform which comprises various software layers that are configured to perform various functions, including, but not limited to, generating and implementing various quantum applications using suitable quantum programming languages, configuring and implementing various quantum gate operations, compiling quantum programs into a quantum assembly language, implementing and utilizing a suitable quantum instruction set architecture (ISA), performing calibration operations to calibrate the quantum circuit elements and gate operations, etc. In addition, the quantum computing platform 1010 comprises a hardware architecture of processors, memory, etc., which is configured to control the execution of quantum applications, and interface with the control system 1030 to (i) generate digital control signals that are converted to analog microwave control signals by the control system 1030, to control operations of the quantum processor 1042 when executing a given quantum application, and (ii) to obtain and process digital signals received from the control system 1030, which represent the processing results generated by the quantum processor 1042 when executing various gate operations for a given quantum application.

In some exemplary embodiments, the quantum computing platform 1010 of the quantum computing system 1000 may be implemented using any suitable computing system architecture which is configured to implement methods to support quantum computing operations by executing computer readable program instructions that are embodied on a computer program product which includes a computer readable storage medium (or media) having such computer readable program instructions thereon for causing a processor to perform control methods as discussed herein.

The quantum computing platform 1010 comprises a software and hardware platform which comprises various software layers that are configured to perform various functions, including, but not limited to, generating and implementing various quantum applications using suitable quantum programming languages, configuring and implementing various quantum gate operations, compiling quantum programs into a quantum assembly language, implementing and utilizing a suitable quantum instruction set architecture (ISA), performing calibration operations to calibrate the quantum circuit elements and gate operations, etc. In addition, the quantum computing platform 1010 comprises a hardware architecture of processors, memory, etc., which is configured to control the execution of quantum applications, and interface with the control system 1030 to (i) generate digital control signals that are converted to analog microwave control signals by the control system 1030, to control operations of the quantum processor 1042 when executing a given quantum application, and (ii) to obtain and process digital signals received from the control system 1030, which represent the processing results generated by the quantum processor 1042 when executing various gate operations for a given quantum application. In some exemplary embodiments, the quantum computing platform 1010 of the quantum computing system 1000 may be implemented using any suitable computing system architecture which is configured to implement methods to support quantum computing operations by executing computer readable program instructions that are embodied on a computer program product which includes a computer readable storage medium (or media) having such computer readable program instructions thereon for causing a processor to perform control methods as discussed herein.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes”, “has”, “possesses”, and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a prediction component configured to:
parse program code to identify a conditional operation in the program code;
generate a prediction of an outcome of the conditional operation; and
speculatively execute an operation in the program code in accordance with the prediction; and
a rewind component configured to:
rewind, in response to a determination that the prediction was incorrect, the speculatively executed operation.

2. The system of claim 1, wherein the program code is configured to control operation of a quantum computer system.

3. The system of claim 1, wherein the conditional operation comprises executing a first operation or executing a second operation.

4. The system of claim 3, wherein the first operation is speculatively executed by the prediction component.

5. The system of claim 4, wherein the rewind component is further configured to:
monitor execution of the first operation to determine a first state resulting from the speculative execution of the first operation;
generate a rewind operation configured to enact a second state, wherein the second state is a conditional state prior to speculative execution of the first operation; and
apply the rewind operation to the speculatively executed operation.

6. The system of claim 5, wherein the rewind operation comprises one of a conjugate transpose of the first state, a compliment of the first state, utilizing a sequence of gates having an operation that is the compliment to the first state, utilizing a sequence of operations having a combined operation that is the compliment of the first state, or a sequence of gates and operations that combine to be the compliment of the first state.

7. The system of claim 1, wherein the conditional operation in the program code is a first conditional operation and the program code is a first program code, the prediction component is further configured to:
identify second program code having a second conditional operation similar to the first conditional operation in the first program code, wherein the second program code is executed prior to the first program code; and
identify a second prior outcome of the second conditional operation.

8. The system of claim 7, wherein the prediction component is further configured to:
generate the predicted outcome of the first conditional operation based on the second prior outcome of the second conditional operation.

9. The system of claim 1, wherein the conditional operation applies to a conditional operation of one of a logic gate or a quantum bit (qubit) in a quantum circuit.

10. The system of claim 9, further comprising a weighting component configured to:
receive a characteristic regarding the logic gate or the qubit;
generate a weighting based on the characteristic; and
apply the weighting to the prediction to adjust the prediction in accordance with the characteristic.

11. The system of claim 10, wherein the characteristic is at least one of a high readout error, crosstalk, or qubit entanglement.

12. A computer-implemented method performed by a device operatively coupled to a processor, wherein the method comprising:
predicting an outcome of a conditional operation in a program code, wherein the program code is configured to control operation of a quantum computer system;
speculatively executing an operation in the program code in accordance with the prediction; and
rewinding, in response to a determination that the prediction was incorrect, the speculatively executed operation.

13. The computer-implemented method of claim 12, wherein the conditional operation comprises executing a first operation or executing a second operation.

14. The computer-implemented method of claim 13, further comprising:
monitoring execution of the first operation;
determining a first state resulting from the speculative execution of the first operation;
generating a rewind operation configured to enact a second state, wherein the second state is a conditional state prior to speculative execution of the first operation; and
applying the rewind operation to the speculatively executed operation.

15. The computer-implemented method of claim 14, wherein the rewind operation comprises one of a conjugate transpose of the first state, a compliment of the first state, utilizing a sequence of gates having an operation that is the compliment to the first state, utilizing a sequence of operations having a combined operation that is the compliment of the first state, or a sequence of gates and operations that combine to be the compliment of the first state.

16. The computer-implemented method of claim 15, further comprising:
identifying, in a quantum circuit, one of a logic gate or a quantum bit (qubit) to which the conditional operation applies;
receiving a characteristic regarding the logic gate or the qubit;
generating a weighting based on the characteristic; and
applying the weighting to the prediction to adjust the prediction in accordance with the characteristic.

17. A computer program product stored on a non-transitory computer-readable medium and comprising machine-executable instructions, wherein, in response to being executed, the machine-executable instructions cause a machine to perform operations, comprising:
predicting an outcome of a conditional operation in a program code, wherein the program code is configured to control operation of a quantum computer system;
speculatively executing an operation in the program code in accordance with the prediction; and
rewinding, in response to a determination that the prediction was incorrect, the speculatively executed operation.

18. The computer program product according to claim 17, wherein the conditional operation comprises executing a first operation or executing a second operation, and the operations further comprise:
monitoring execution of the first operation;
determining a first state resulting from the speculative execution of the first operation;
generating a rewind operation configured to enact a second state, wherein the second state is a conditional state of the quantum computer system prior to speculative execution of the first operation; and
applying the rewind operation to the speculatively executed operation.

19. The computer program product according to claim 18, wherein the rewind operation comprises one of a conjugate transpose of the first state, a compliment of the first state, utilizing a sequence of gates having an operation that is the compliment to the first state, utilizing a sequence of operations having a combined operation that is the compliment of the first state, or a sequence of gates and operations that combine to be the compliment of the first state.

20. The computer program product according to claim 17, wherein the operations further comprise:
identifying, in a quantum circuit in the quantum computer system, one of a logic gate or a quantum bit (qubit) to which the conditional operation applies;
receiving a characteristic regarding the logic gate or the qubit;
generating a weighting based on the characteristic; and
applying the weighting to the prediction to adjust the prediction in accordance with the characteristic.
